(19) United States
(12) Patent Application Publication
(10) Pub. No.: US 2015/0003902 A1
(43) Pub. Date: Jan. 1, 2015

(54) TIPPED SURFACES FOR MIXED MATERIAL JOINING AND METHODS OF MAKING AND USING THE SAME

(71) Applicant: GM Global Technology Operations LLC, Detroit, MI (US)

(72) Inventors: Robert N. Saje, Shelby Township, MI (US); Artur Wyszynski, Oxford, MI (US); Keith J. Saari, Macomb Township, MI (US); Peter M. Parlow, Columbus, MI (US); John C. Johnson, Macomb Township, MI (US)

(21) Appl. No.: 13/930,721

(22) Filed: Jun. 28, 2013

(51) Int. Cl. F16B 5/02

(52) U.S. Cl. CPC F16B 5/02
USPC 403/306

(57) ABSTRACT

A number of variations may include a substrate having a tipped surface constructed and arranged to make a joint with another substrate.

### TECHNICAL FIELD

The field to which the disclosure generally relates to includes substrates having surfaces for forming a joint with another substrate.

### BACKGROUND

Joints between two substrates may be made by a variety of methods.

### SUMMARY OF ILLUSTRATIVE VARIATIONS

A number of variations may include a substrate having a tipped surface constructed and arranged to make a joint with another substrate.

Other illustrative variations within the scope of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a product including a product including a tipped surface constructed and arranged for making a joint with another substrate according to a number of variations.

FIG. 2 illustrates a method of joining a first substrate having a tipped surface to another substrate utilizing a flow drill screw gun to insert a flow drill screw through the second substrate and through the first substrate at the tipped surface.

FIG. 3 illustrates a substrate having a pocket formed therein by a plurality of wall portions according to a number of variations.

FIG. 4 illustrates a substrate in the form of a front hinge pillar having a first side including a pocket constructed and arranged to receive the pointed end of a flow drill screw according to a number of variations.

FIG. 5 illustrates a second side of the front hinge pillar shown in FIG. 4 and wherein the second side includes tipped surfaces for adjoining to another substrate according to a number of variations.

FIG. 6 illustrates a substrate including a double-sided attachment pocket having opposing tipped surfaces each for forming a joint with another substrate according to a number of variations.

FIG. 7 illustrates a substrate having a plurality of tipped surfaces constructed and arranged to provide double-sided reverse pockets according to a number of variations.

### DETAILED DESCRIPTION OF ILLUSTRATIVE VARIATIONS

The following description of the variations is merely illustrative in nature and is in no way intended to limit the scope of the invention, its application, or uses.

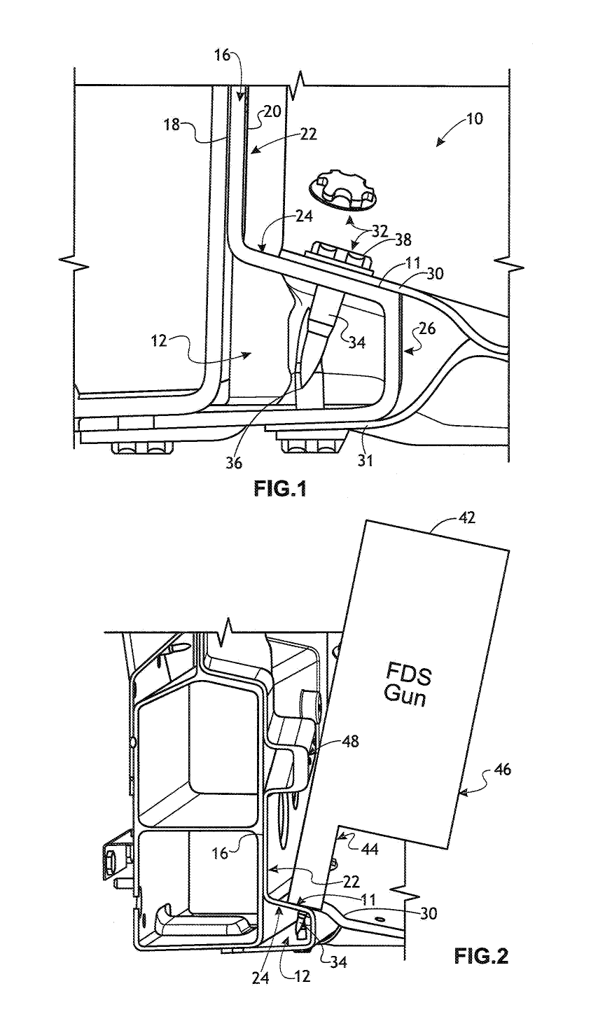

Referring now to FIG. 1, a number of variations may include product 10 which may include a substrate having a tipped surface 11 constructed and arranged for making a joint with another substrate. In a number of variations, the product 10 may be constructed and arranged to define a pocket 12 for receiving the sharp end of a fastener. In a number of variations, the product 10 may include a substrate 16 having a first inner face 18 and an opposite outer face 20. The substrate 16 may include a first wall portion 22 which joins a second wall portion 24 which joins a third wall portion 26 which joins a fourth wall portion 28. The first wall portion 22, second wall portion 24, third wall portion 26 and fourth wall portion 28 may define, at least in part, the pocket 12 for receiving a fastener. In a number of variations the substrate 16 may be a casting such as, but not limited to, a high pressure die-casting of an aluminum alloy. In a number of variations, the first wall portion 22 has an outer face 20 having a straight portion, which has formed an obtuse angle with respect to the outer face of the second portion 24.

As will be appreciated from FIG. 2, the tipped surface 11 of the second portion 24 may be constructed and arranged to allow a flow drill screw gun to insert a flow drill screw 32 through the first substrate 16 and a second substrate 30 wherein the flow drill screw is drilled into the tipped surface 11 of the second wall portion 24. The flow drill screw gun 40 may include a narrow portion 44 which drives a head 38 of the flow drill screw 32 so that a pointed tip 36 at the end of a shaft 34 pierces the second substrate 30 and the second wall portion 24 of the first substrate and any adhesive layer interposed between the first substrate 16 and second substrate 30. The second portion 24 of the first substrate 16 may be constructed and arranged and tipped so that the wider upper portion 46 of the flow drill screw gun 42 avoids contact with the first portion 22 of the substrate 16 and any other protrusions 48 of the first substrate 16.

Referring again to FIG. 1, a second flow drill screw 40 may be utilized to pierce a third substrate 31 and the fourth wall portion 28 of the first substrate 16 to attach the third substrate 31 to the first substrate 16. In a number of variations, the first substrate 16 may be a front hinge pillar of a vehicle, the second substrate may be a steel vehicle dash panel and the third substrate may be a floor panel of the vehicle.

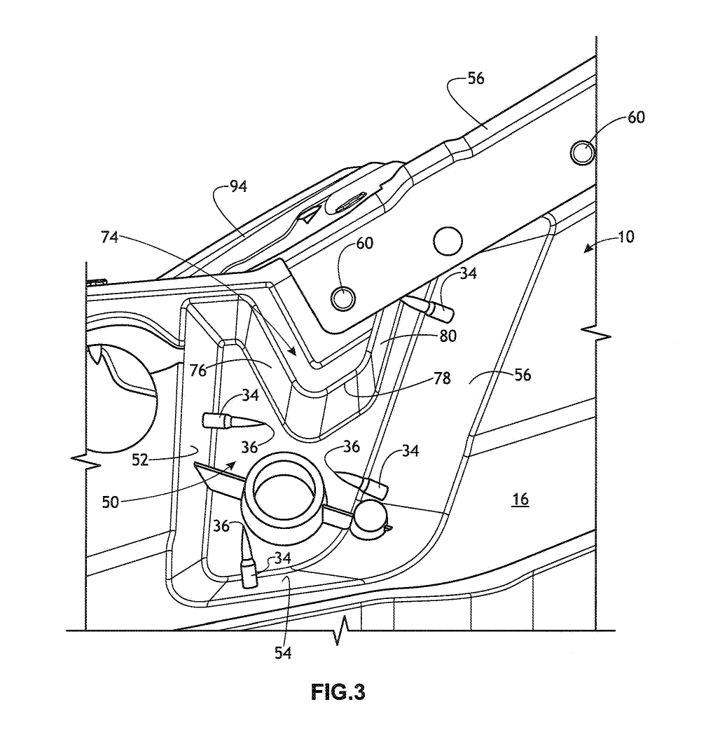

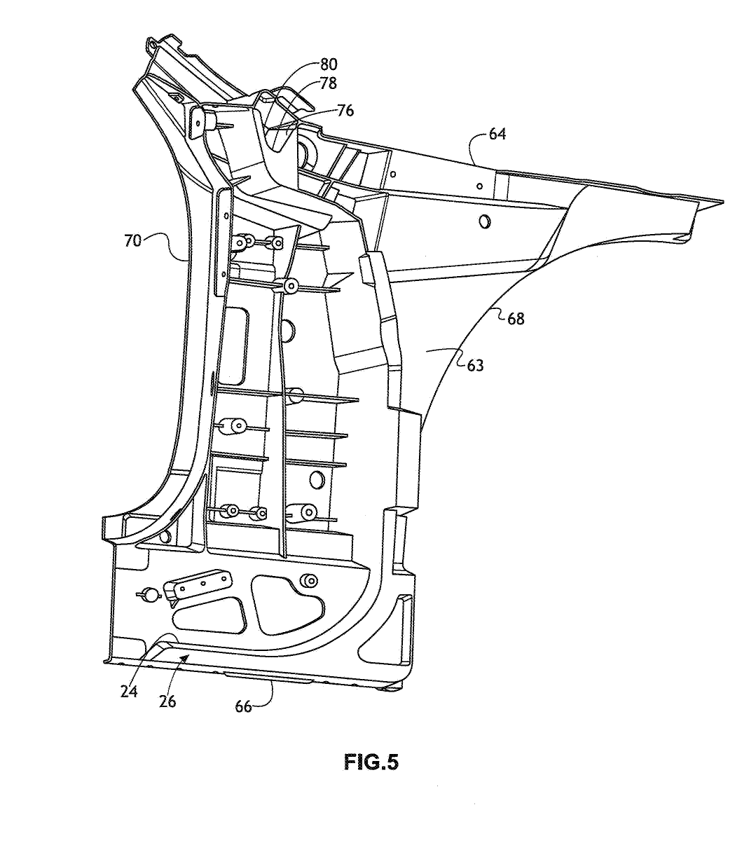

Referring now to FIG. 3, in a number of variations the product 10 may include a first substrate 16 which is constructed and arranged to define a second pocket 50 for receiving a portion of each of a plurality of flow drill screws 32. The second pocket 50 may be defined, at least in part, by a first wall portion 52 joining a second wall portion 54 joining a third wall portion 56. The first wall portion 52 may have an outer planar face formed at an acute angle with an outer planar face of the second wall portion 54, and the third wall portion 56 may have an outer planar face formed at an obtuse angle with respect to the outer planar face of the second wall portion 54. The outer planar face of the third wall portion 56 may also be tilted or skewed with respect to the outer planar face of the second wall portion 54. Each of the first wall portion 52, second wall portion 54, and third wall portion 56 may include an opposite inner face formed in the opposite side 18 of the substrate 16 (shown in FIG. 1) and which is generally parallel to the outer face of each of the wall portions 52, 54, and 56. A raised feature 74 may be provided in the substrate 16 and may include a first wall portion 76, second wall portion 78 and third wall portion 80 which define in the opposite face 18 a third pocket 72 best seen in FIG. 5.

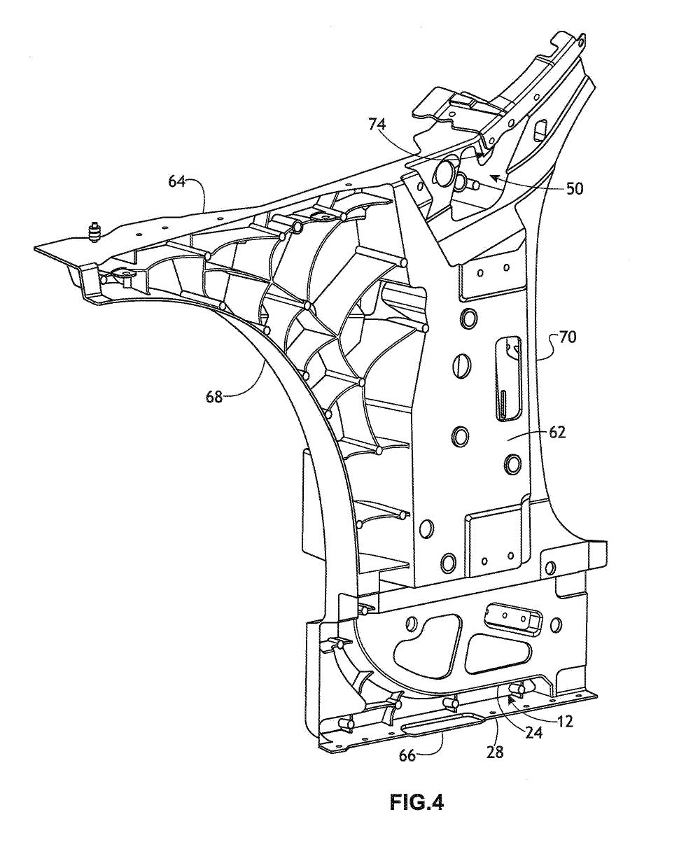

Referring now to FIGS. 4-5, the product 10 may include a single piece casting in the form of a cast front hinge pillar which may include a top edge 64 and opposite bottom edge 66, a first arcuate or curved surface 68 constructed and arranged to define, at least in part, a vehicle wheel well, and an opposite second arcuate or curved surface 70 constructed and arranged to define, at least in part, a door well of a vehicle. Because features in the first face 62 and second face 63 of the cast front hinge pillar include tipped or tilted surfaces, or surfaces that are slanted with respect to the direction of movement of casting die halves or the direction of movement of the cast product upon release from the cast die, the front hinge pillar can be cast in a molding die so that a first die half associated with the first face 62 may be easily removed and similarly a second die half associated with forming the second face 63 may be easily removed after molten alloy has been cast in the die and solidified. The tipped or tilted surfaces or slanted surfaces do not catch on the mold die halves as the halves are opened to release the cast product or the solidified cast product is removed from the de,

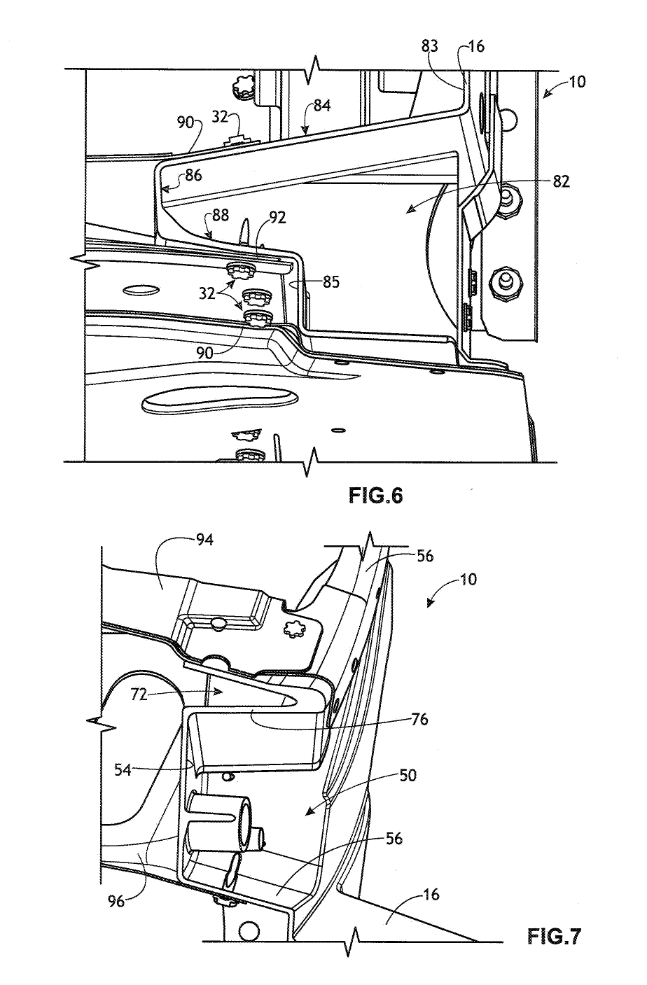

Referring now to FIG. 6, in a number of variations the product 10 may include a substrate constructed and arranged to provide a third pocket 82 which may be a double sided attachment pocket which may be formed by a second wall portion 84 joining a third wall portion 86 joining a fourth wall portion 88. The second wail portion 84 has a planar face formed at an obtuse angle with respect to a planar face of a first wall portion 83. The second wall portion 84 may include an outer surface having a planar face which is formed at an obtuse angle with an outer surface having a planar face of the third wall portion 86. Similarly, the fourth wall portion 88 may include an outer surface having a planar face which has formed at an obtuse angle with an outer planar face of the third wall portion 86. The tipped surfaces of the second wall portion 84 and fourth wall portion 88 allow for the attachment of a first sheet 90 to the second wall portion 86 using a flow drill screw 32 and the attachment of a second sheet of material 92 to the fourth wall portion 88 utilizing a flow drill screw 32.

Referring now to FIG. 7, in a number of variations, the product 10 may include a substrate 16 constructed and arranged to provide double sided reverse pockets 50 and 72 which share a common wall portion 76. A number of sheets of other material 94, 96 may be attached to the substrate 16 on either or both faces thereof and at a variety of angles utilizing the wall portion defining the reverse pockets 50 and 72.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product comprising: a substrate including a first face and an opposite second face, the substrate including a first wall portion joining a second wall portion, the first wall portion having an outer surface having a planar face, a second wall portion having an outer surface having a planar face formed at an obtuse angle to the planar face of the first wall portion and constructed and arranged to facilitate attachment of a second substrate to the second wall portion using a flow drill screw driven by a flow drill screw gun.

Variation 2 may include a product as set forth in Variation 1, further comprising a third wall portion joining the second wall portion and a fourth wall portion joining the third wall portion, and wherein the second wall portion, third wall portion and fourth wall portion define, at least in part, a pocket for receiving a portion of a fastener.

Variation 3 may include a product as set forth in any of Variations 1-2, further comprising a second pocket formed in the opposite second face of the substrate, the second pocket being defined at least in part by a fifth wall portion, a sixth wall portion and a seventh wall portion.

Variation 4 may include a product as set forth in any of Variations 1-2, wherein the second face of the substrate has a second pocket formed therein wherein the first pocket and second pocket are defined at least in part by a common wall portion.

Variation 5 may include a product as set forth in any of Variations 2-4, wherein the third wall portion includes an outer surface having a planar face and wherein the fourth wall portion has an outer surface having a planar face, and wherein the planar face of the fourth wall is formed at an obtuse angle with respect to the planar face of the third wall portion so that the second wall portion and the fourth wall portion provide opposite attachment surfaces each for the insertion of a fastener therethrough.

Variation 6 may include a product as set forth in any of Variations 1-5, wherein the substrate comprises a high pressure die-casted aluminum alloy.

Variation 7 may include a method comprising: providing a substrate including a first face and an opposite second face, the substrate including a first wall portion joining a second wall portion, wherein the first wall portion includes an outer surface having a planar face and wherein the second wall portion includes an outer surface having a planar face and wherein the planar face of the second wall portion is formed at an obtuse angle to the planar face of the first wall portion; attaching a second substrate to the first substrate comprising placing the second substrate over the planar face of the second wall portion and inserting a flow drill screw through the second substrate and the second wall portion at the planar face thereof to provide a joint between the first substrate and the second substrate, wherein the inserting a flow drill screw through the second substrate and the second wall portion at the planar face thereof comprises driving the flow drill screw with a flow drill gun operated so that the flow drill screw gun does not contact the first wall portion during the driving the flow drill screw.

Variation 8 may include a product as set forth in Variation 7, wherein the attaching further comprising interposing an adhesive layer between the first substrate and second substrate to adhere the first substrate and second substrate together prior to the inserting a flow drill screw through the second substrate and the second wall portion at the planar face thereof.

Variation 9 may include a product as set forth in any of Variations 7-8, further comprising a third wall portion joining the second wall portion and a fourth wall portion joining the third wall portion, and wherein the second wall portion, third wall portion and fourth wall portion define, at least in part, a first pocket for receiving a portion of flow drill screw.

Variation 10 may include a product as set forth in any of Variations 7-9, wherein the flow drill screw includes a head and a shaft extending from the head and wherein the shaft includes a pointed end, and wherein a portion of the shaft and the pointed end are received in the first pocket.

Variation 11 may include a product as set forth in any of Variations 7-10, further comprising a second pocket formed in the opposite second face of the substrate, the second pocket being defined at least in part by a fifth wall portion, a sixth wall portion and a seventh wall portion.

Variation 12 may include a product as set forth in any of Variations 7-11, wherein the second face of the substrate has a second pocket formed therein wherein the first pocket and second pocket are defined at least in part by a common wall portion.

Variation 13 may include a product as set forth in any of Variations 8-12, wherein the third wall portion includes an outer surface having a planar face and wherein the fourth wall portion has an outer surface having a planar face, and wherein the planar face of the fourth wall is formed at an obtuse angle with respect to the planar face of the third wall portion so that the second wall portion and the fourth wall portion provide opposite attachment surfaces each for the insertion of a fastener therethrough.

Variation 14 may include a product as set forth in Variation 13, wherein the first substrate includes a fifth wall portion joining the fourth wall portion, and wherein the fifth wall portion includes an outer surface having a planar face, and wherein the planar fact of the fifth wall portion is formed at an obtuse angle to the planar face of the fourth wall portion; and further comprising attaching a third substrate to the first substrate comprising placing the third substrate over the planar face of the fourth wall portion and inserting a flow drill screw through the third substrate and the fourth wall portion at the planar face thereof to provide a joint between the first substrate and the third substrate, wherein the inserting a flow drill screw through the third substrate and the fourth wall portion at the planar face thereof comprises driving the flow drill screw with a flow drill gun operated so that the flow drill screw gun does not contact the fifth wall portion during the driving the flow drill screw.

Variation 15 may include a product as set forth in any of Variations 7-14, wherein the substrate comprises a high pressure die-casted aluminum alloy.

Variation 16 may include a product as set forth in any of Variations 7-15, further comprising attaching a third substrate to the first substrate.

The above description of select variations within the scope of the invention is merely illustrative in nature and, thus, variations or variants thereof are not to be regarded as a departure from the spirit and scope of the invention.

1. A product comprising:
a substrate including a first face and an opposite second face, the substrate including a first wall portion joining a second wall portion, the first wall portion having an outer surface having a planar face, a second wall portion having an outer surface having a planar face formed at an obtuse angle to the planar face of the first wall portion and constructed and arranged to facilitate attachment of a second substrate to the second wall portion using a flow drill screw driven by a flow drill screw gun.

2. A product as set forth in claim 1, further comprising a third wall portion joining the second wall portion and a fourth wall portion joining the third wall portion, and wherein the second wall portion, third wall portion and fourth wall portion define, at least in part, a pocket for receiving a portion of a fastener.

3. A product as set forth in claim 2, further comprising a second pocket formed in the opposite second face of the substrate, the second pocket being defined at least in part by a fifth wall portion, a sixth wall portion and a seventh wall portion.

4. A product as set forth in claim 1, wherein the second face of the substrate has a second pocket formed therein wherein the first pocket and second pocket are defined at least in part by a common wall portion.

5. A product as set forth in claim 2 wherein the third wall portion includes an outer surface having a planar face and wherein the fourth wall portion has an outer surface having a planar face, and wherein the planar face of the fourth wall is formed at an obtuse angle with respect to the planar face of the third wall portion so that the second wall portion and the fourth wall portion provide opposite attachment surfaces each for the insertion of a fastener therethrough.

6. A product as set forth in claim 1 wherein the substrate comprises a high pressure die-casted aluminum alloy.

7. A method comprising:
providing a substrate including a first face and an opposite second face, the substrate including a first wall portion joining a second wall portion, wherein the first wall portion includes an outer surface having a planar face and wherein the second wall portion includes an outer surface having a planar face and wherein the planar face of the second wall portion is formed at an obtuse angle to the planar face of the first wall portion;
attaching a second substrate to the first substrate comprising placing the second substrate over the planar face of the second wall portion and inserting a flow drill screw through the second substrate and the second wall portion at the planar face thereof to provide a joint between the first substrate and the second substrate, wherein the inserting a flow drill screw through the second substrate and the second wall portion at the planar face thereof comprises driving the flow drill screw with a flow drill gun operated so that the flow drill screw gun does not contact the first wall portion during the driving the flow drill screw.

8. A method as set forth in claim 7 wherein the attaching further comprising interposing an adhesive layer between the first substrate and second substrate to adhere the first substrate and second substrate together prior to the inserting a flow drill screw through the second substrate and the second wall portion at the planar face thereof.

9. A method as set forth in claim 7, further comprising a third wall portion joining the second wall portion and a fourth wall portion joining the third wall portion, and wherein the second wall portion, third wall portion and fourth wall portion define, at least in part, a first pocket for receiving a portion of flow drill screw.

10. A method as set forth in claim 9 where in the flow drill screw includes a head and a shaft extending from the head and wherein the shaft includes a pointed end, and wherein a portion of the shaft and the pointed end are received in the first pocket.

11. A method as set forth in claim 9, further comprising a second pocket formed in the opposite second face of the substrate, the second pocket being defined at least in part by a fifth wall portion, a sixth wall portion and a seventh wall portion.

12. A method as set forth in claim 7, wherein the second face of the substrate has a second pocket formed therein wherein the first pocket and second pocket are defined at least in part by a common wall portion.

13. A method as set forth in claim 9 wherein the third wall portion includes an outer surface having a planar face and wherein the fourth wall portion has an outer surface having a planar face, and wherein the planar face of the fourth wall is formed at an obtuse angle with respect to the planar face of the third wall portion so that the second wall portion and the fourth wall portion provide opposite attachment surfaces each for the insertion of a fastener therethrough.

14. A method as set forth in claim 13 wherein the first substrate includes a fifth wall portion joining the fourth wall portion, and wherein the fifth wall portion includes an outer surface having a planar face, and wherein the planar fact of the fifth wall portion is formed at an obtuse angle to the planar face of the fourth wall portion;
and further comprising attaching a third substrate to the first substrate comprising placing the third substrate over the planar face of the fourth wall portion and inserting a flow drill screw through the third substrate and the fourth wall portion at the planar face thereof to provide a joint between the first substrate and the third substrate, wherein the inserting a flow drill screw through the third substrate and the fourth wall portion at the planar face thereof comprises driving the flow drill screw with a flow drill gun operated so that the flow drill screw gun does not contact the fifth wall portion during the driving the flow drill screw.

15. A method as set forth in claim 7 wherein the substrate comprises a high pressure die-casted aluminum alloy.

16. A method as set forth in claim 7 further comprising attaching a third substrate to the first substrate.
